(19) United States
(12) Patent Application Publication
(10) Pub. No.: US 2024/0217029 A1
(43) Pub. Date: Jul. 4, 2024

(54) LASER PROCESSING APPARATUS

(71) Applicant: DISCO CORPORATION, Tokyo (JP)

(72) Inventor: Tsubasa HIROSE, Tokyo (JP)

(21) Appl. No.: 18/539,713

(22) Filed: Dec. 14, 2023

(30) Foreign Application Priority Data
Dec. 28, 2022 (JP) 2022-211450

(51) Int. Cl. B23K 26/0622

(52) U.S. Cl. CPC B23K 26/0622

(57) ABSTRACT

A laser processing apparatus includes a laser beam generation unit having a laser oscillation source for emitting laser pulse signals at a high repetitive frequency, a pulsed laser beam setting section for setting the number of laser pulse signals so as to emit a single pulsed laser beam that includes the set number, a pulse period setting section for decimating laser pulse signals from the laser oscillation source to set a period between pulsed laser beams that are adjacent to each other, and a power amplifying section for amplifying the pulsed laser beams. The pulsed laser beams have a repetitive frequency set to a value calculated by dividing the high repetitive frequency by a sum of the number of laser pulse signals that make up the single pulsed laser beam and the number of laser pulse signals to be decimated at one location.

### BACKGROUND OF THE INVENTION

### Field of the Invention

The present invention relates to a laser processing apparatus.

### Description of the Related Art

Wafers with a plurality of devices such as integrated circuits (ICs) or large scale integration (LSI) circuits constructed in respective areas demarcated in their face side by a grid of projected dicing lines are divided into individual device chips by a laser processing apparatus. The device chips will be used in electronic appliances such as cellular phones or personal computers.

The laser processing apparatus includes a holding unit for holding a workpiece thereon, a laser beam applying unit for applying a laser beam to the workpiece held under the holding unit, and a feed mechanism for processing-feeding the holding unit and the laser beam applying unit relatively to each other. The laser processing apparatus can process the workpiece as desired with a laser beam emitted from the laser beam applying unit (see, for example, Japanese patent No. 6151557).

### SUMMARY OF THE INVENTION

However, when the laser beam is applied to the workpiece along projected dicing lines on the workpiece, cracks tend to extend from the projected dicing lines along crystal structure of the workpiece, possibly causing damage to devices on the workpiece. The problems manifest itself in a case where the workpiece is in the form of a wafer made of a compound semiconductor including a silicon carbide (Sic).

Furthermore, there are occasions where the workpiece may not be processed with satisfactory results even though attempts are made to adjust processing conditions such as a laser beam power level, a processing feed speed, and a focused spot position in view of the heat retained by the workpiece when the laser beam is applied to the workpiece.

It is therefore an object of the present invention to provide a laser processing apparatus that is capable of processing a workpiece as desired.

In accordance with an aspect of the present invention, there is provided a laser processing apparatus including a chuck table for holding a workpiece thereon, a laser beam applying unit for applying a laser beam to the workpiece held on the chuck table, and a processing-feeding the chuck table and the laser beam applying unit relatively to each other. The laser beam applying unit includes a laser beam generation unit for emitting a pulsed laser beam and a beam condenser for converging the pulsed laser beam emitted from the laser beam generation unit and applying the pulsed laser beam to the workpiece held on the chuck table. The laser beam generation unit includes a laser oscillation source for emitting laser pulse signals at a high repetitive frequency, a pulsed laser beam setting section for setting the number of laser pulse signals to be emitted from the laser oscillation source to enable the laser oscillation source to emit a single pulsed laser beam that includes the set number of laser pulse signals, a pulse period setting section for decimating laser pulse signals to be emitted from the laser oscillation source to set a period between pulsed laser beams that are adjacent to each other, and a power amplifying section for amplifying a power of the pulsed laser beams with the pulse period set therebetween. The pulsed laser beams have a repetitive frequency set to a value calculated by dividing the high repetitive frequency by a sum of the number of laser pulse signals that make up the single pulsed laser beam and the number of laser pulse signals to be decimated at one location, and the pulsed laser beams have a pulse duration set to a value calculated by multiplying a value produced by subtracting “1” from the number of laser pulse signals that has been set by the pulsed laser beam setting section, by the reciprocal of the high repetitive frequency.

Preferably, the high repetitive frequency is equal to or higher than 100 MHz. Preferably, the pulsed laser beam setting section, the pulse period setting section, and the power amplifying section make settings depending on the kind and crystal structure of the workpiece.

According to the present invention, the laser processing apparatus is capable of adjusting the repetitive frequency and the pulse duration in addition to the power of the pulsed laser beams, a feed speed of the workpiece, and the position of a focused spot of the pulsed laser beams. Inasmuch as the laser processing apparatus makes it possible to adjust processing conditions flexibly depending on the kind and crystal structure of the workpiece and the heat retained by the workpiece, the laser processing apparatus can process the workpiece as desired.

The above and other objects, features and advantages of the present invention and the manner of realizing them will become more apparent, and the invention itself will best be understood from a study of the following description and appended claims with reference to the attached drawings showing a preferred embodiment of the invention.

### BRIEF DESCRIPTION OF THE DRAWINGS

FIG. 1 is a perspective view of a laser processing apparatus according to an embodiment of the present invention;

FIG. 2 is a block diagram, partly in perspective, of a laser beam applying unit of the laser beam applying unit illustrated in FIG. 1; and

FIG. 3 is a block diagram of a laser beam generation unit of the laser beam applying unit illustrated in FIG. 2.

### DETAILED DESCRIPTION OF THE PREFERRED EMBODIMENT

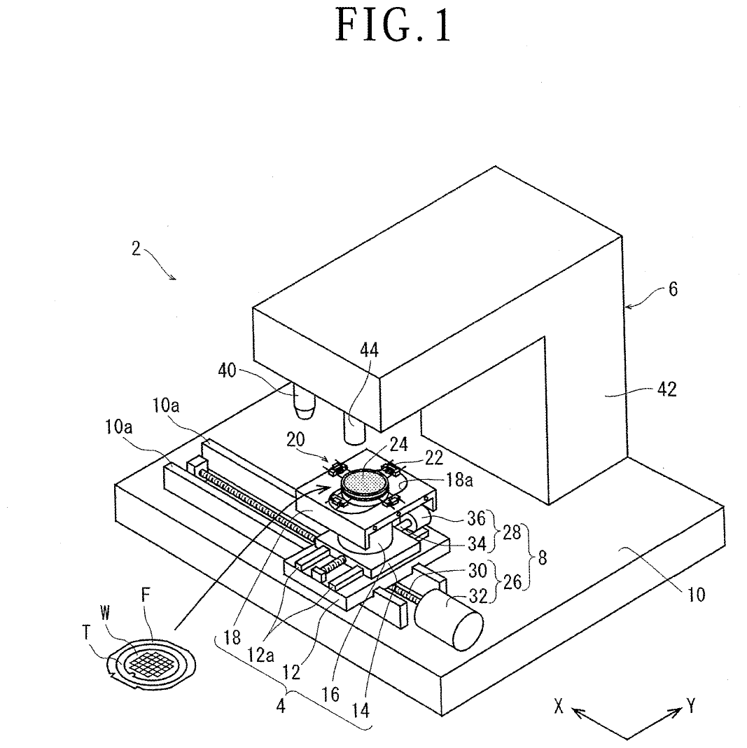

A laser processing apparatus according to a preferred embodiment of the present invention will be described in detail below with reference to the accompanying drawings. As illustrated in FIG. 1, the laser processing apparatus, denoted by 2, includes a holding unit 4 for holding a workpiece thereon, a laser beam applying unit 6 for applying a laser beam to the workpiece held under the holding unit 4, and a feed assembly 8 for processing-feeding the holding unit 4 and the laser beam applying unit 6 relatively to each other.

The holding unit 4 includes an X-axis movable plate 12 supported on an upper surface of a base 10 for movement along an X-axis, a Y-axis movable plate 14 supported on an upper surface of the X-axis movable plate 12 for movement along a Y-axis, a support post 16 fixedly mounted on an upper surface of the Y-axis movable plate 14, and a cover plate 18 mounted on the upper end of the support post 16. The cover plate 18 has an oblong hole 18a defined therein that extends along the Y-axis. A circular chuck table 20 that extends upwardly through the oblong hole 18a is rotatably mounted on the upper end of the support post 16. A plurality of clamps 22 that are circumferentially spaced at angular intervals are disposed on a circumferential edge of the chuck table 20.

A circular porous suction chuck 24 for holding the workpiece under suction thereon is disposed on an upper end surface of the chuck table 20. The suction chuck 24 is fluidly connected to suction means, not depicted. When the suction means is actuated, it generates and transmits a suction force to the upper surface of the suction chuck 24, causing the suction chuck 24 to hold the workpiece under suction thereon. The chuck table 20 is rotatable about its vertical central axis by an electric motor, not depicted, housed in the support post 16.

In FIG. 1, the X-axis is indicated by the arrow X whereas the Y-axis is indicated by the arrow Y and extends perpendicularly to the X-axis. The X-axis and the Y-axis jointly define an XY plane that lies essentially horizontally.

According to the present embodiment, the feed assembly 8 includes an X-axis feed mechanism 26 for processing-feeding the chuck table 20 along the X-axis and a Y-axis feed mechanism 28 for indexing-feeding the chuck table 20 along the Y-axis.

The X-axis feed mechanism 26 has a ball screw 30 coupled to the X-axis movable plate 12 and extending along the Y-axis and an electric motor 32 for rotating the ball screw 30 about its central axis parallel to the X-axis. The X-axis feed mechanism 26 converts rotary motion of the electric motor 32 into linear motion with the ball screw 30 and transmits the linear motion to the X-axis movable plate 12 for thereby moving the X-axis movable plate 12 along a pair of guide rails 10a on the base 10 that extend along the X-axis. In this manner, the chuck table 20 is processing-fed along the X-axis.

The Y-axis feed mechanism 28 has a ball screw 34 coupled to the Y-axis movable plate 14 and extending along the Y-axis and an electric motor 36 for rotating the ball screw 34 about its central axis parallel to the Y-axis. The Y-axis feed mechanism 28 converts rotary motion of the electric motor 36 into linear motion with the ball screw 34 and transmits the linear motion to the Y-axis movable plate 14 for thereby moving the Y-axis movable plate 14 along a pair of guide rails 12a on the Y-axis movable plate 14 that extend along the Y-axis. In this manner, the chuck table 20 is indexing-fed along the Y-axis.

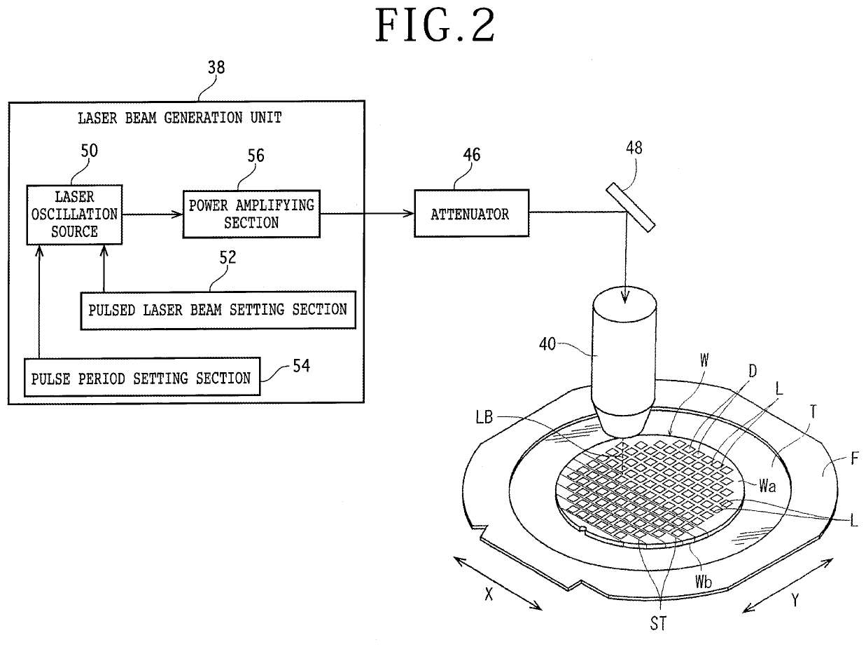

As illustrated in FIGS. 1 and 2, the laser beam applying unit 6 includes a laser beam generation unit 38 (see FIG. 2) for emitting pulsed laser beams LB and a beam condenser 40 for converging the pulsed laser beams LB emitted from the laser beam generation unit 38 and applying the converged pulsed laser beams LB to the workpiece held under the holding unit 4.

As illustrated in FIG. 1, the laser beam applying unit 6 has a housing 42 including a vertical block extending upwardly from an upper surface of the base 10 and a horizontal arm extending essentially horizontally from an upper portion of the vertical block in overhanging relation to the holding unit 4. The laser beam generation unit 38 is housed in the housing 42, and the beam condenser 40 is mounted on a lower surface of a distal end portion of the horizontal arm of the housing 42. An image capturing unit 44 for capturing an image of the workpiece held under the holding unit 4 is also mounted on a lower surface of the distal end portion of the horizontal arm of the housing 42 adjacent to the beam condenser 40.

As illustrated in FIG. 2, the laser beam applying unit 6 has an attenuator 46 for regulating the power of the pulsed laser beams LB emitted from the laser beam generation unit 38 and a mirror 48 for reflecting the pulsed laser beams LB from the attenuator 46 toward the beam condenser 40.

As illustrated in FIG. 2, the laser beam generation unit 38 includes a laser oscillation source 50, a pulsed laser beam setting section 52, a pulse period setting section 54, and a power amplifying section 56. The laser oscillation source 50 emits laser pulse signals at a high repetitive frequency of 100 MHZ, for example.

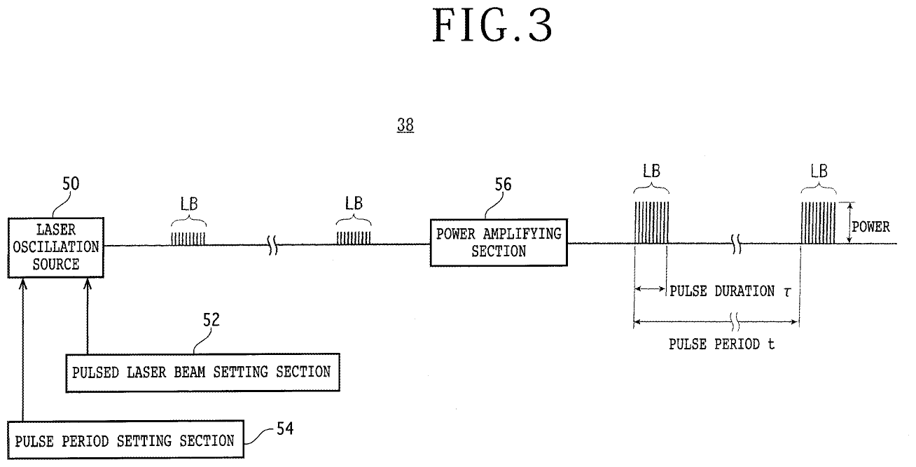

The pulsed laser beam setting section 52 sets the number of laser pulse signals to be emitted from the laser oscillation source 50 to a certain value, enabling the laser oscillation source 50 to emit a single pulsed laser beam LB that includes the set number of laser pulse signals. For example, as illustrated in FIG. 3, the pulsed laser beam setting section 52 sets the number of laser pulse signals to be emitted from the laser oscillation source 50 to “10,” so that the laser oscillation source 50 can emit a single pulsed laser beam LB that includes 10 laser pulse signals.

The pulse duration of the pulsed laser beam LB is set to a value calculated by multiplying a value produced by subtracting “1” from the number of laser pulse signals that has been set by the pulsed laser beam setting section 52, by the reciprocal of the high repetitive frequency of the laser pulse signals to be emitted from the laser oscillation source 50 (see Equation (1) below).

$$τ = ( {N}_{1} - 1 ) / {F}_{P} \qquad ( 1 )$$

Where, τ, N₁, and F_{P} are as the followings in the Equation (1).
τ: the pulse duration of the pulsed laser beam LB;
N₁: the number of laser pulse signals set by the pulsed laser beam setting section 52 (the number of laser pulse signals that make up a single pulsed laser beam LB); and
F_{P}: the high repetitive frequency of the laser pulse signals to be emitted from the laser oscillation source 50.

For example, if the number N₁ of laser pulse signals set by the pulsed laser beam setting section 52 is “10” and the high repetitive frequency F_{P} is 1 GHZ, then the pulse duration τ of the pulsed laser beam LB is calculated as 9 ns, i.e., approximately 10 ns, according to the above Equation (1).

The pulse period setting section 54 decimates laser pulse signals to be emitted from the laser oscillation source 50 to set a period (pulse period) between a pulsed laser beam LB and an adjacent pulsed laser beam LB. Stated otherwise, the pulse period setting section 54 sets a repetitive frequency of pulsed laser beams LB by decimating laser pulse signals from between a pulsed laser beam LB and an adjacent pulsed laser beam LB.

The repetitive frequency, denoted by F_{L}, of pulsed laser beams LB is set to a value calculated by dividing the high repetitive frequency F_{P} of the laser pulse signals to be emitted from the laser oscillation source 50 by the sum of the number N₁ of laser pulse signals that make up a pulsed laser beam LB and the number N₂ of laser pulse signals to be decimated from one location (see Equation (2) below).

$${F}_{L} = {F}_{P} / ( {N}_{1} + {N}_{2} ) \qquad ( 2 )$$

Where, F_{L}, F_{P}, N₁ and N₂ are as the followings in the Equation (2).
N₁: the number of laser pulse signals set by the pulsed laser beam setting section 52 (the number of laser pulse signals making up a pulsed laser beam LB);
N₂: the number of laser pulse signals to be decimated from one location;
F_{L}: the repetitive frequency of pulsed laser beams LB; and
F_{P}: the high repetitive frequency of the laser pulse signals to be emitted from the laser oscillation source 50.

For example, if the number N₁ of laser pulse signals “10” and the high repetitive frequency F_{P} is 1 GHz, then when the repetitive frequency F_{L} of pulsed laser beams LB is to be set to 10 kHz, the number N₂ of laser pulse signals to be decimated from one location is calculated as “99990” according to the above Equation (2).

If the number N₁ of laser pulse signals “10” and the high repetitive frequency F_{P} is 1 GHZ, then the pulse period setting section 54 sets the repetitive frequency F_{L} of pulsed laser beams LB to 10 kHz by decimating 99990 laser pulse signals from between a pulsed laser beam LB and an adjacent pulsed laser beam LB. When the repetitive frequency F_{L} is 10 kHz, the pulse period t between pulsed laser beams LB is 100 μs.

As illustrated in FIG. 3, the power amplifying section 56 amplifies the power of the pulsed laser beams LB with the pulse period t set therebetween.

As described above, the laser processing apparatus 2 is capable of adjusting the number N₁ of laser pulse signals that make up a pulsed laser beam LB, and the pulse duration τ, the repetitive frequency F_{L} (pulse period t), and the power of pulsed laser beams LB to desired values.

FIG. 2 also illustrates a wafer W as the workpiece to be processed by the laser processing apparatus 2. The wafer W, shaped as a circular plate, is made of a suitable semiconductor material such as silicon, for example. The wafer W has a face side Wa, depicted as facing upwardly, having a plurality of rectangular areas demarcated by a grid of projected dicing lines L. A plurality of devices D such as ICs or LSI circuits, for example, are constructed respectively in the rectangular areas. According to the present embodiment, the wafer W has a reverse side Wb, depicted as facing downwardly opposite the face side Wa, which is affixed to an adhesive tape T mounted on an annular frame F and positioned centrally in a circular opening defined by the annular frame F. Alternatively, the face side Wa of the wafer W may be affixed to the adhesive tape T.

A process of forming shield tunnels each having a slender hole and an amorphous substance surrounding the slender hole in the wafer W along the projected dicing lines L on the laser processing apparatus 2 will be described below.

According to the present embodiment, the wafer W with the face side Wa facing upwardly is held under suction on the upper surface of the suction chuck 24. The annular frame F that supports the wafer W is secured in place by the clamps 22. Then, the image capturing unit 44 captures an image of the wafer W, and the chuck table 20 is turned about its central axis to align those projected dicing lines L that extend in a first direction with the X-axis on the basis of the captured image. Furthermore, the feed assembly 8 and the laser beam applying unit 6 are operated to position a focused spot of the pulsed laser beams LB within the wafer W at one of the projected dicing lines L that have been aligned with the X-axis.

Then, while the X-axis feed mechanism 26 is processing-feeding the chuck table 20 along the X-axis, the beam condenser 40 applies the pulsed laser beams LB, which have a wavelength transmittable through the wafer W, to the wafer W along the projected dicing line L. The applied pulsed laser beams LB form a plurality of shield tunnels ST, not depicted, in the wafer W along the projected dicing line L. Each of the shield tunnels ST include a slender hole extending from the face side Wa to the reverse side Wb of the wafer W and an amorphous substance surrounding the slender hole.

Then, the Y-axis feed mechanism 28 indexing-feeds the chuck table 20 along the Y-axis by a distance corresponding to the interval between adjacent two of the projected dicing lines L. Thereafter, while the X-axis feed mechanism 26 is processing-feeding the chuck table 20 along the X-axis, the beam condenser 40 applies the pulsed laser beams LB to the wafer W along a next projected dicing line L. The process of applying the pulsed laser beams LB while processing-feeding the chuck table 20 and the process of indexing-feeding the chuck table 20 are alternatively repeated to form shield tunnels ST in the wafer W along all the projected dicing lines L that extend in the first direction.

Then, the chuck table 20 is turned 90 degrees about its central axis. Thereafter, the process of applying the pulsed laser beams LB while processing-feeding the chuck table 20 and the process of indexing-feeding the chuck table 20 are alternatively repeated to form shield tunnels ST in the wafer W along all the projected dicing lines L that extend in a second direction perpendicular to the projected dicing lines L along the first direction along which the shield tunnels ST have previously been formed in the wafer W. In this manner, the shield tunnels ST are formed in a grid pattern along all the projected dicing lines L on the wafer W. Thereafter, the adhesive tape T is pulled radially outwardly, dividing the wafer W into individual device chips including the respective devices D along the shield tunnels ST in the grid pattern.

For performing the laser processing process for forming shield tunnels ST, for example, in the workpiece such as the wafer W, the pulsed laser beam setting section 52, the pulse period setting section 54, and the power amplifying section 56 can make appropriate settings depending on the kind and crystal structure of the workpiece. Specifically, the pulsed laser beam setting section 52, the pulse period setting section 54, and the power amplifying section 56 can adjust or set the number N₁ of laser pulse signals that make up a single pulsed laser beam LB, the pulse duration τ of the pulsed laser beam LB, the repetitive frequency F_{L} (pulse period t) and power of the pulsed laser beams LB depending on the kind and crystal structure of the workpiece.

### <Experiment>

In order to find processing conditions for forming appropriate shield tunnels in an SiC wafer, the applicant of the present application conducted an experiment under the following conditions.

### (Laser Oscillation Source)

Wavelength: 1064 nm
High repetitive frequency: 1 GHZ
Pulse duration of pulse signals: 500 fs

### (Workpiece)

Sic wafers having a thickness of 700 μm

### (Processing Conditions)

| | | | Number N₂ | |
|---|---|---|---|---|
| | Number | | of laser | |
| | N₁ of | | pulse | |
| | laser | | signals | Repetitive |
| | pulse | Pulse | to be | frequency |
| Conditions | signals | duration τ | decimated | F_{L} |
| A | 50 | Approximately | 99950 | 10 kHz |
| | | 50 ns | | |
| B | 100 | Approximately | 99900 | 10 kHz |
| | | 100 ns | | |
| C | 200 | Approximately | 99800 | 10 kHz |
| | | 200 ns | | |
| D | 400 | Approximately | 99600 | 10 kHz |
| | | 400 ns | | |
| E | 800 | Approximately | 99200 | 10 kHz |
| | | 800 ns | | |
| F | 1600 | Approximately | 98400 | 10 kHz |
| | | 1600 ns | | |
| G | 3200 | Approximately | 96800 | 10 kHz |
| | | 3200 ns | | |

### (Other Processing Conditions)

Processing type: Formation of shield tunnels
Average power of pulsed laser beams: 0.5 to 3.0 W
Processing feed speed: 100 to 1000 mm/s
Spot interval: 10 to 100 μm

### (Experimental Results)

It was the conditions E and F that shield tunnels were appropriately formed in the SiC wafers and the SiC wafers were cut or divided well without being affected by their crystal structure. The other processing conditions in the conditions E and F were the average power of 1 to 1.5 W, the processing feed speed of 200 mm/s, and the spot interval of 20 μm.

The applicant conducted an experiment, similar to the above experiment, where the number N₂ of laser pulse signals to be decimated was changed to set the repetitive frequency F_{L} to 100 kHz. It was the condition B that shield tunnels were appropriately formed in the SiC wafer and the SiC wafer was cut or divided well without being affected by their crystal structure. The other processing conditions in the condition B were the average power of 1 to 1.5 W, the processing feed speed of 1000 mm/s, and the spot interval of 10 μm.

There are various different processing conditions for forming shield tunnels depending on the conditions A through G and combinations of other processing conditions, and it is extremely difficult to establish a set of processing conditions for forming appropriate shield tunnels. According to the present embodiment, as described above, the laser processing apparatus 2 is able to adjust the number N₁ of laser pulse signals that make up a single pulsed laser beam LB, the pulse duration τ of the pulsed laser beam LB, the repetitive frequency F_{L} (pulse period t) and power of the pulsed laser beams LB to desired values. Therefore, it is possible to adjust processing conditions flexibly depending on the kind, e.g., SiC, silicon, sapphire, or quarts, of the workpiece and the crystal structure of the workpiece to find processing conditions for appropriately processing the workpiece.

However, if the high repetitive frequency F_{P} of laser pulse signals to be emitted from the laser oscillation source 50 is below 100 MHz, then it is difficult for the pulsed laser beam setting section 52 and the pulse period setting section 54 to make adjustment. Consequently, it is preferable that the high repetitive frequency F_{P} be equal to or higher than 100 MHZ.

The processing type is not limited to the formation of shield tunnels but may be an ablation process on the workpiece or a process of forming modified layers in the workpiece. The wavelength of the pulsed laser beams LB emitted from the laser oscillation source 50 is not limited to 1064 nm described above and may be selected from suitable wavelengths of 266 nm, 355 nm, and 532 nm, for example, depending on the processing type and the kind of the workpiece.

As described above, the laser processing apparatus 2 according to the present embodiment is capable of adjusting the repetitive frequency F_{L} (pulse period t) and the pulse duration τ in addition to the power of the pulsed laser beams LB, the processing feed speed, and the position of the focused spot. Inasmuch as the laser processing apparatus 2 makes it possible to adjust processing conditions flexibly depending on the kind and crystal structure of the workpiece and the heat retained by the workpiece, the laser processing apparatus 2 can process the workpiece as desired.

The present invention is not limited to the details of the above described preferred embodiment. The scope of the invention is defined by the appended claims and all changes and modifications as fall within the equivalence of the scope of the claims are therefore to be embraced by the invention.

What is claimed is:

1. A laser processing apparatus comprising:
a chuck table for holding a workpiece thereon;
a laser beam applying unit for applying a laser beam to the workpiece held on the chuck table; and
a processing-feeding the chuck table and the laser beam applying unit relatively to each other,
wherein the laser beam applying unit includes:
a laser beam generation unit for emitting a pulsed laser beam, and
a beam condenser for converging the pulsed laser beam emitted from the laser beam generation unit and applying the pulsed laser beam to the workpiece held on the chuck table, and
the laser beam generation unit includes:
a laser oscillation source for emitting laser pulse signals at a high repetitive frequency,
a pulsed laser beam setting section for setting the number of laser pulse signals to be emitted from the laser oscillation source to enable the laser oscillation source to emit a single pulsed laser beam that includes the set number of laser pulse signals,
a pulse period setting section for decimating laser pulse signals to be emitted from the laser oscillation source to set a period between pulsed laser beams that are adjacent to each other, and
a power amplifying section for amplifying a power of the pulsed laser beams with the pulse period set therebetween,
wherein the pulsed laser beams have a repetitive frequency set to a value calculated by dividing the high repetitive frequency by a sum of the number of laser pulse signals that make up the single pulsed laser beam and the number of laser pulse signals to be decimated at one location, and
the pulsed laser beams have a pulse duration set to a value calculated by multiplying a value produced by subtracting “1” from the number of laser pulse signals that has been set by the pulsed laser beam setting section, by the reciprocal of the high repetitive frequency.

2. The laser processing apparatus according to claim 1, wherein the high repetitive frequency is equal to or higher than 100 MHZ.

3. The laser processing apparatus according to claim 1, wherein the pulsed laser beam setting section, the pulse period setting section, and the power amplifying section make settings depending on the kind and crystal structure of the workpiece.
